(19) United States
(12) Patent Application Publication
(10) Pub. No.: US 2024/0218731 A1
(43) Pub. Date: Jul. 4, 2024

(54) DOOR PANEL SEALING MECHANISM AND DOOR HAVING THE SAME

(71) Applicant: Hsia-Sen LIN, Taoyuan City (TW)

(72) Inventor: Hsia-Sen LIN, Taoyuan City (TW)

(21) Appl. No.: 18/177,917

(22) Filed: Mar. 3, 2023

(30) Foreign Application Priority Data
Jan. 3, 2023 (TW) 112100123

(51) Int. Cl. E06B 7/215

(52) U.S. Cl. CPC E06B 7/215

(57) ABSTRACT

A door panel sealing mechanism includes at least one actuating devices and a sealing device. The actuating devices each include an elastic element, a sliding element, a first interlocking element, and a second interlocking element. The sealing device is connected with the second interlocking element of the actuating devices. A door including the door panel sealing mechanism is also disclosed.

### CROSS REFERENCE TO RELATED APPLICATION

This application claims the benefits of the Taiwan Patent Application Serial Number 112100123, filed on Jan. 3, 2023, the subject matter of which is incorporated herein by reference.

### BACKGROUND

### 1. Field of the Invention

The present invention relates to a door panel sealing mechanism and a door having the same.

### 2. Description of Related Art

In the prior art, a door panel needs to keep a certain gap from the floor as a swiveling space maintained for opening or closing the door, so as to avoid the action of opening or closing the door being intervened by foreign matters on the floor. However, the existence of such gap not only adversely affects the aesthetic appearance of the door, but also fails to meet the requirements of the fire service regulations. The existence of such gap typically makes it necessary for a door panel to incorporate a protruding threshold to keep sealing of the door panel with the threshold and with the door frame, and to achieve the purposes of airtight, waterproof, insect prevention, anti-smog, and fire prevention.

However, in the aforementioned prior art, since the door panel and the threshold have to be matched with each other, the installation of the door becomes difficult, and at the same time, the arrangement of the threshold will likely to adversely affect the aesthetic appearance of the door. Besides, in daily life, people are easily to kick the protruding threshold and thus fall down, and this makes living unsafe.

Given that the aforementioned problems are inherent in the prior art, it is necessary to innovate a brand new door panel sealing mechanism so as to solve such problems.

### SUMMARY

In view of the above, an aspect of the present invention is to provide a door panel sealing mechanism, such that there is no need for an extra work on installing a threshold to be incorporated with the door panel. Besides, there are advantages such as easy construction, aesthetic appearance, and safety. The door panel sealing mechanism according to the present invention includes two actuating devices, a sealing device, and an interlocking device. The actuating devices each include an elastic element, a sliding element, a first interlocking element, and a second interlocking element. The sliding element is arranged on the elastic element, such that in case the sliding element is moved by a force, the elastic element will be compressed. In contrast, suppose the sliding element is no more subject to the force, the elastic element will provide an elastic force to move the sliding element back to its original position. The first interlocking element is arranged on the sliding element and is provided with a guiding rail. The second interlocking element is arranged on the guiding rail of the first interlocking element and is provided with a slot. The slot is arranged corresponding to the guiding rail of the first interlocking element. Besides, the sealing device is connected respectively with the second interlocking elements of the two actuating devices. The interlocking device is connected respectively with the first interlocking elements of the two actuating devices. As such, the sliding element is interlocked with the first interlocking elements and the interlocking device, which then move synchronously the second interlocking elements, making the sealing device, which is connected with the second interlocking elements, move synchronously, and thereby the door panel and floor can be sealed.

Further, another aspect of the present invention is to provide a door having a door panel and an aforementioned door panel sealing mechanism, wherein the structure, purpose, and function of the door panel sealing mechanism are identical to those of the aforementioned, and therefore the detailed description is omitted. At any rate, the door panel sealing mechanism is mounted to the door panel, and in more detail, the door panel sealing mechanism is arranged underneath the door panel, though not so limited, namely it is possible to adjust the arrangement of the position of the door panel sealing mechanism to meet the practical requirement.

According to the present invention, each of the actuating devices further includes a housing, wherein the housing is provided with a first opening, a second opening, and a third opening. The sliding element corresponds to the first opening, the second interlocking element corresponds to the second opening, and the interlocking device passes through the third opening, though not so limited. In more detail, the sliding element may extend out or not extend out of the first opening, and the second interlocking element may extend out of the second opening, such that the sliding element can, upon closing the door, contact a door frame, so as to interlock a first interlocking element, the second interlocking element, and a sealing device.

According to the present invention, each of the actuating devices further includes a housing, wherein the housing is provided with a first chamber and a second chamber, the elastic element is received in the first chamber, and the first interlocking element is received in the second chamber, though not so limited.

According to the present invention, the sliding element is provided with a first protruding block, wherein the first protruding block is arranged on the elastic element, though not so limited, such that the sliding element can be interlocked with the elastic element.

According to the present invention, the sliding element is provided with a first through hole, wherein the first interlocking element is arranged in the first through hole, though not so limited, such that the sliding element can be interlocked with the first interlocking element.

According to the present invention, the sliding element is provided with a second through hole, and the first interlocking element is provided with a second protruding block, wherein the second protruding block is arranged in the second through hole, though not so limited, such that a protrusion of the first interlocking element can be arranged in the first through hole of the sliding element.

According to the present invention, the sliding element includes a rolling element, wherein the rolling element has its axis of rotation be perpendicular to an elastically acting force of the elastic element, though not so limited, such that the rolling element can be arranged corresponding to a door frame. As such, with the help of the rolling element contacting with the door frame, the sliding element can move synchronously. The rolling element, according to the present invention, relates to a universal ball, though not so limited.

According to the present invention, the second interlocking element is arranged on the guiding rail of the first interlocking element by means of a first fixing element, and the second interlocking element is provided with a slot, wherein the slot is arranged corresponding to the guiding rail of the first interlocking element, though not so limited, such that the second interlocking element can move following the guiding rail of the first interlocking element, making the sealing device, which is connected with the second interlocking element, move synchronously, so as to achieve a sealing effect between the door panel and the floor.

According to the present invent, the sealing device includes a first sealing element and a second sealing element, wherein the first sealing element is arranged beneath an underneath surface of the sealing device, and the second sealing element is arranged on a side surface of the sealing device, though not so limited, so as to enhance a sealing effect.

According to the present invent, the first sealing element and the second sealing element are made of rubber, Ethylene Vinyl Acetate foam (EVA), Polyethylene foam (PE), or their combination, though not so limited.

According to the present invention, the elastic elements relate but not limited to springs.

According to the present invention, the interlocking device includes a first rod, a second rod, and an adjusting element, wherein the first rod is connected with the first interlocking element of either one of the actuating devices, the second rod is connected with the first interlocking element of the other actuating device, and the adjusting element is arranged between the first rod and the second rod, so as to transmit the force acting from the sliding element.

According to the present invention, a gap between the door panel and the floor is 1 to 5 cm; preferably 1 to 4 cm; more preferably 1 to 3 cm; or even more preferably 1 to 2 cm, though not so limited.

Other objects, advantages, and novel features of the invention will become more apparent from the following detailed description when taken in conjunction with the accompanying drawings.

### BRIEF DESCRIPTION OF THE DRAWINGS

FIG. 1 is a cross-sectional view illustrating the door panel sealing mechanism according to one embodiment of the present invention;

FIGS. 2 to 5 are schematic views illustrating an actuating mechanism of the door panel sealing mechanism according one embodiment of the present invention;

FIG. 6 is a schematic view illustrating the door panel sealing mechanism according one embodiment of the present invention;

FIG. 7 is a schematic view illustrating a door having the door panel sealing mechanism according to one embodiment of the present invention;

FIG. 8 is a cross-sectional view illustrating the door panel sealing mechanism according to another embodiment of the present invention;

FIG. 9 is a schematic view illustrating the door panel sealing mechanism according to another embodiment of the present invention; and

FIG. 10 is a schematic view illustrating a door having the door panel sealing mechanism according to another embodiment of the present invention.

### DETAILED DESCRIPTION OF THE EMBODIMENT

The following are proposed with various embodiments of the present invention, and these embodiments are provided for describing the contents of techniques of the present invention, rather than for limiting the claimed scope of the present invention. It is understood that the features of any particular embodiment can be applied to other embodiments by way of appropriate modifications, replacement, combination, or detachment.

It is noted that in the text of the specification, unless otherwise identified, having “an” element does not limit to having single one of such element, but instead may refer to one or more of such elements.

Further, unless otherwise identified, ordinal numbers “first,” “second,” and so forth are provided for distinguishing plural elements having the same names, rather than indicating that an order exists among them for rank, level, execution order, or process order. Namely, a “first” element and a “second” element may appear in the same structural member, or in different structural members. The existence of an element having a greater ordinal number does not necessarily means the existence of another element having a smaller ordinal number.

In the text of the specification, unless otherwise indicated, the so-called feature A “or” or “and/or” feature B indicates that A exists alone, or B exists alone, or A and B coexist; and the so-called feature A “and” feature B indicate that A and B coexist. The so-called “including”, “comprising”, “having”, or “containing” refers to “including but not limited thereto”.

Further, in the text of the specification, the term “up,” “down,” “left,” “right,” “front,” “rear,”, or “between” is just provided for describing relative positions among plural elements, and can be expanded into the case after translation, rotation, or mirroring.

Still further, in the text of specification, unless otherwise indicated, “an element is above another element,” or similar description, does not necessarily mean that the element is in contact with the other element.

### [The Structure of the Door Panel Sealing Mechanism 100]

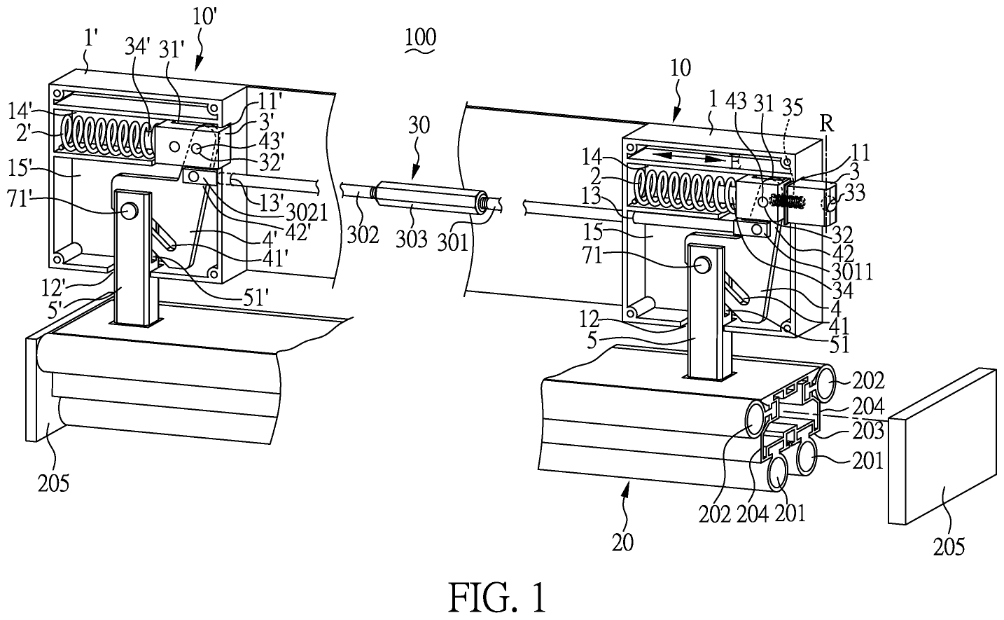

FIG. 1 is a cross-sectional view illustrating the door panel sealing mechanism 100 according to one embodiment of the present invention.

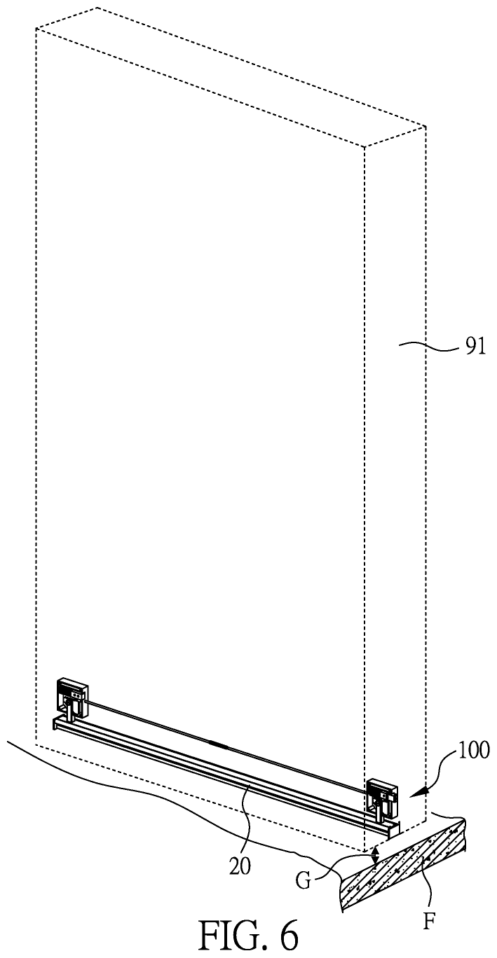

FIG. 6 is a schematic view illustrating the door panel sealing mechanism 100 according to one embodiment of the present invention.

As shown in FIGS. 1 and 6, the door panel sealing mechanism 100 of this embodiment includes a first actuating device 10, a second actuating device 10′, a sealing device 20, and an interlocking device 30. The first actuating device 10 includes a housing 1, an elastic element 2, a sliding element 3, a first interlocking element 4, and a second interlocking element 5. The housing 1 is provided with a first opening 11, a second opening 12, a third opening 13, a first chamber 14, and a second chamber 15. The sliding element 3 extends out of the first opening 11. The second interlocking element 5 extends out of the second opening 12. The interlocking device 30 passes through the third opening 13. The third opening 13 is arranged adjacent to the elastic element 2. The elastic element 2 is received in the first chamber 14 of the housing 1. The first interlocking element 4 is received in the second chamber 15.

The sliding element 3 is provided with a first through hole 31, a second through hole 32, a rolling element 33, and a first protruding block 34. The rolling element 33 of the sliding element 3 is arranged corresponding to a door frame 92. The rolling element 33 has its axis of rotation R be perpendicular to an elastically acting force E of the elastic element 2. As such, with the help of the rolling element 33, the resistance occurred due to contacting the door frame 92 can be reduced, and provide better user experience. Besides, the sliding element 3 is provided therein a threaded adjusting stem 35 for fine-tuning a moving distance as the sliding element 3 is subject to a force. Further, the first protruding block 34 of the sliding element 3 is arranged on the elastic element 2, and a second protruding block 43 of the first interlocking element 4 is arranged in the second through hole 32 of the sliding element 3, such that a protrusion 42 of the first interlocking element 4 can be arranged and fixed in the first through hole 31 of the sliding element 3. The rolling element 33 in this embodiment relates to a universal ball, though not so limited.

The first interlocking element 4 is provided with a guiding rail 41. The second interlocking element 5 is provided with a slot 51. The slot 51 is arranged corresponding to the guiding rail 41 of the first interlocking element 4. The first interlocking element 4 is disposed in the slot 51 of the second interlocking element 5. The second interlocking element 5 is arranged on the rail 41 of the first interlocking element 4 through a first fixing element 71.

Still further, the structure of the second actuating device 10′ is similar to that of the first actuating device 10. The second actuating device 10′ includes a housing 1′, an elastic element 2′, a sliding element 3′, a first interlocking element 4′, and a second interlocking element 5′. The housing 1′ is provided with a first opening 11′, a second opening 12′, a third opening 13′, a first chamber 14′, and a second chamber 15′. The sliding element 3′ is provided with a first through hole 31′, a second through hole 32′, and a first protruding block 34′. The first interlocking element 4′ is provided with a guiding rail 41′, a protrusion 42′, and a second protruding block 43′. The second interlocking element 5′ is provided with a slot 51′. The second interlocking element 5′ is arranged on the guiding rail 41′ of the first interlocking element 4′ through a first fixing element 71′.

The features of the housing 1′, the elastic element 2′, the sliding element 3′, the first interlocking element 4′, and the second interlocking element 5′ of the second actuating device 10′ are substantially similar respectively to those of the housing 1, the elastic element 2, the sliding element 3, the first interlocking element 4, and the second interlocking element 5 of the first actuating device 10, and as such, the detailed description for them is omitted. However, the second actuating device 10′ is different from the first actuating device 10 in that: the sliding element 3′ does not extend out of the first opening 11, and it does not include a rolling element 33 and a threaded adjusting stem 35; and besides, in the second actuating device 10′, the third opening 13′ is adjacent to the first interlocking element 4′.

Further, the sealing device 20 is connected respectively with the second interlocking element 5 of the first actuating device 10 and with the second interlocking element 5′ of the second actuating device 10′. The sealing device 20 includes a first sealing element 201, a second sealing element 202, and a third sealing element 205. The first sealing element 201 is arranged beneath an underneath surface 203 of the sealing device 20. The second sealing element 202 is arranged on a side surface 204 of the sealing device 20. The third sealing element 205 is arranged on the sealing device 20, for sealing the first sealing element 201 and the second sealing element 202. In this embodiment, the sealing device 20 includes two first sealing elements 201, two second sealing elements 202, and two third sealing elements 205. The first sealing elements 201 and the second sealing elements 202 are made of rubber, the third sealing elements 205 relate to airtight rubber sheets, and the elastic elements 2 relates to spring, though not so limited. In particular, the first sealing elements 201 and the second sealing elements 202 relate to hollow rubber strips. In another embodiment of the present invention, the first sealing elements 201 and the second sealing elements 202 may otherwise be made of Ethylene Vinyl Acetate foam (EVA) or Polyethylene foam (PE).

Still further, the interlocking device 30 includes a first rod 301, a second rod 302, and an adjusting element 303. The first rod 301 is connected with the first interlocking element 4 of the first actuating device 10 through a second fixing element 3011. The second rod 302 is connected with the first interlocking element 4′ of the second actuating device 10′ through a third fixing element 3021. The adjusting element 303 is arranged between the first rod 301 and the second rod 302. As such, the adjusting element 303 can be fine-tuned to adjust the moving distance of the first interlocking element 4′ of the second actuating device 10′. This makes the sealing device 20 move uniformly, so as to achieve the purpose of a satisfactory sealing effect.

### [The Actuating Mechanism of the Door Panel Sealing Mechanism 100]

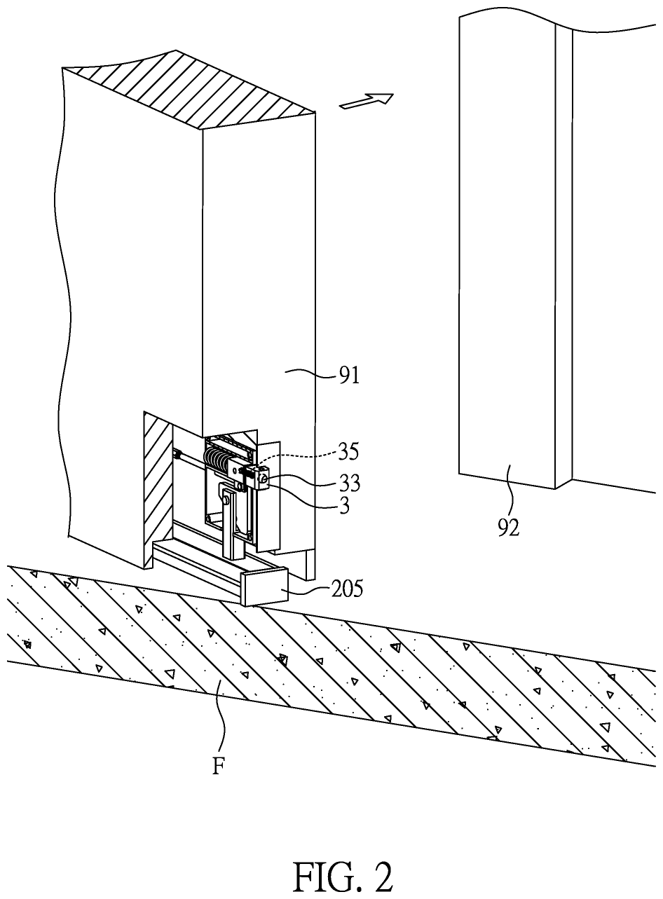

FIGS. 2 to 5 are schematic views illustrating an actuating mechanism of the door panel sealing mechanism 100 according to one embodiment of the present invention.

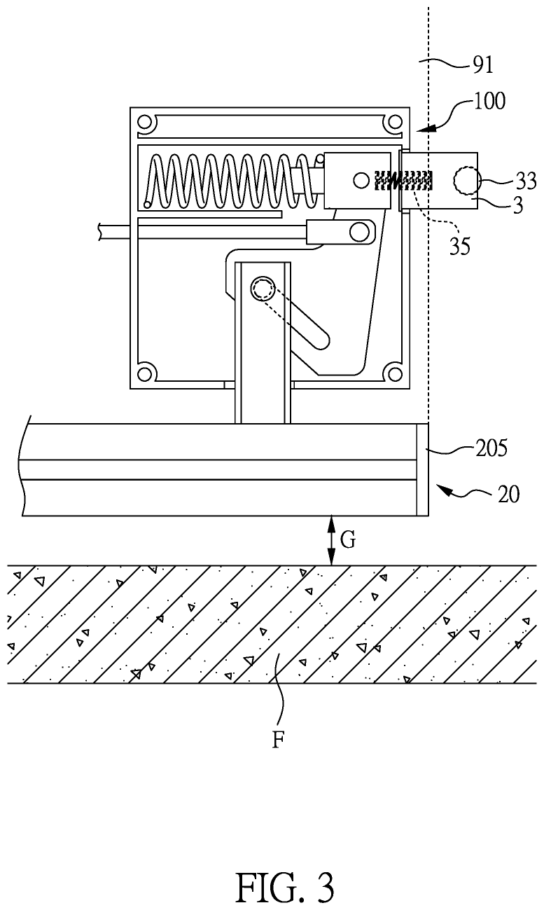

As shown in FIGS. 2 and 3, and also in FIG. 1, at this moment, the door panel 91 is not yet closed, namely the door panel 91 is in a status of opening, and a gap G still exists between the door panel 91 and floor F. The sliding element 3 of the first actuating device 10 stands in an initial status and extends out of the first opening 11 of the housing 1. The sealing device 20 has not been actuated yet, but is still received in the door panel 91. In this case, the gap G is 2 cm, for example.

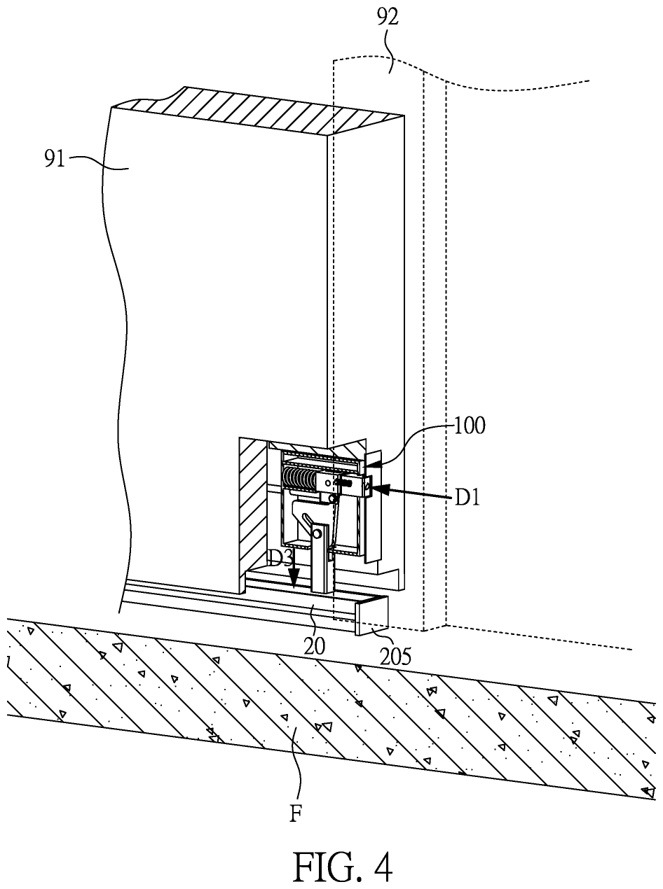

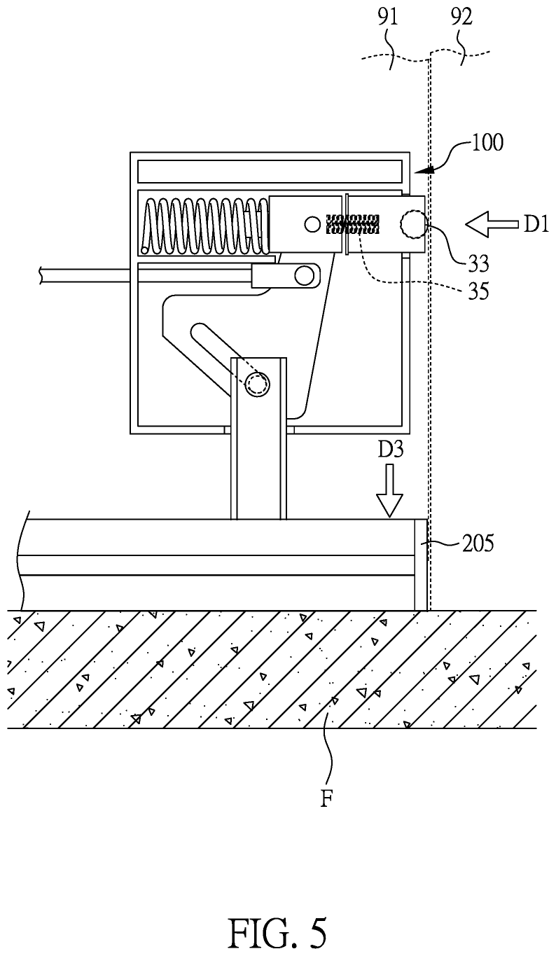

As shown in FIGS. 4 and 5, and also in FIG. 1, at this moment, the door panel 91 is closed, namely the door panel 91 is in a status of closing. As such, the sliding element 3 of the first actuating device 10, which has extended out of the first opening 11 of the housing 1, now has its rolling element 33 contact with the door frame 92, wherein with the help of the rolling element 33, the resistance occurred due to closing the door panel 91 can be reduced, so as to provide better user experience, and thereby the sliding element 3 moves along a direction D1 and compresses against the elastic element 2. Besides, in view of the fact that the protrusion 42 of the first interlocking element 4 is arranged in the first through hole 31 of the sliding element 3, and that the interlocking device 30 is connected respectively with the first interlocking elements 4, 4′, the sliding element 3 is interlocked with the first interlocking elements 4, 4′ and with the interlocking device 30. When the sliding element 3 of the first actuating device 10 moves along the direction D1, the first interlocking elements 4, 4′ and the interlocking device 30 will be interlocked and move along the direction D1. On the other hand, in view of the fact that the second interlocking elements 5, 5′ are arranged on the guiding rails 41, 41′ of the first interlocking elements 4, 4′ respectively through the first fixing elements 71, 71′, the second interlocking elements 5, 5′ are moved respectively along the guiding rails 41, 41′ of the first interlocking elements 4, 4′. Along with movement of the first interlocking elements 4, 4′ along the direction D1, the second interlocking elements 5, 5′ move synchronously along a direction D3. This makes the sealing device 20, which is connected with the second interlocking elements 5, 5′, moves synchronously along the direction D3, and with the help of the first sealing elements 201 and the second sealing elements 202, which are arranged on the sealing device 20, a sealing effect can be achieved by the door panel 91 incorporating with the floor F.

In contrast, in case the sliding element 3 of the first actuating device 10 is no more subject to the force, namely the sliding element 3 of the first actuating device 10 does not contact with the door frame 92, the elastic elements 2, 2′ provide elastic force to move the sliding elements 3, 3′ back to their original positions, making the first interlocking elements 4, 4′, the second interlocking elements 5, 5′, the sealing device 20, and the interlocking device 3, which are interlocked with the sliding elements 3, 3′, return to their original positions. This leaves the gap G to exist between the door panel 91 and the floor F (see FIG. 3), so as to maintain a swiveling space required for closing or opening the door panel 91.

### [The Structure of the Door 9]

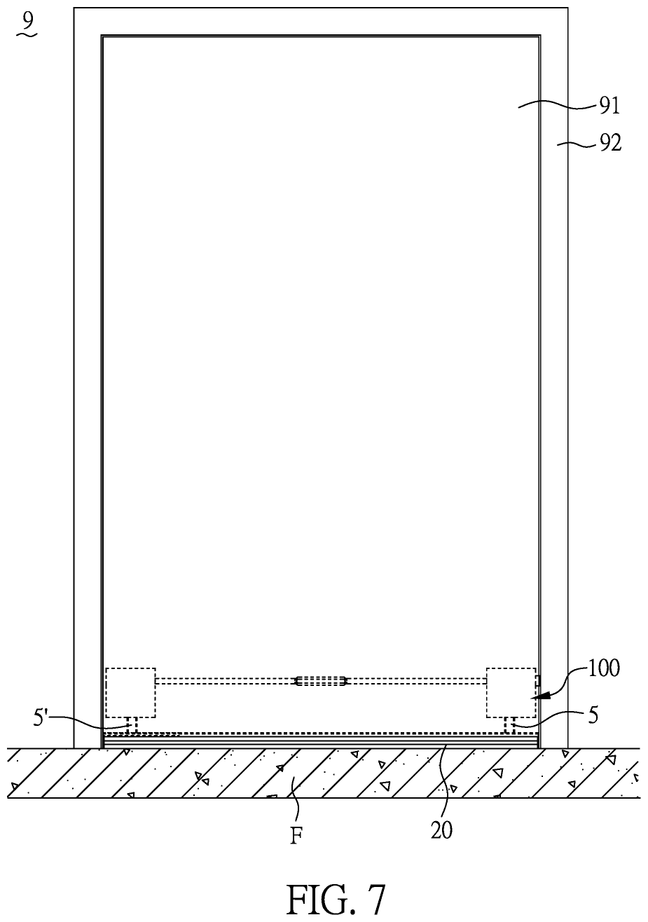

FIG. 7 is a schematic view illustrating a door having the door panel sealing mechanism according to one embodiment of the present invention.

As shown in FIG. 7, and also in FIG. 1, the door 9 includes the door panel 91, the door frame 92, and the door panel sealing mechanism 10. The door panel sealing mechanism 100 is mounted to the door panel 91. The sealing device 20 is arranged on the door panel sealing mechanism 100 and is connected with the second interlocking elements 5, 5′. Since the structure and acting mechanism of the door panel sealing mechanism 100 are substantially similar to the aforementioned, the detailed description is omitted.

### [The Structure of the Door Panel Sealing Mechanism 100 According to Another Embodiment]

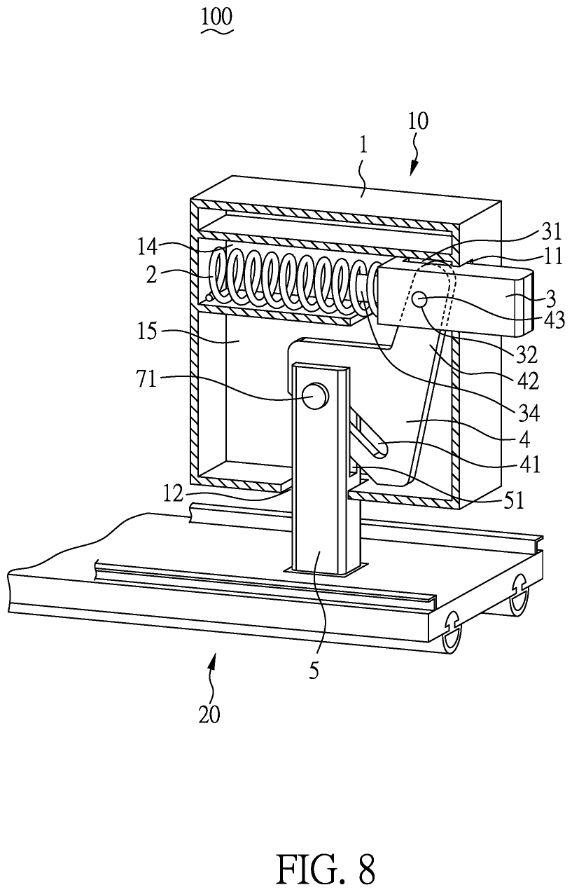

FIG. 8 is a cross-sectional view illustrating the door panel sealing mechanism according to another embodiment of the present invention;

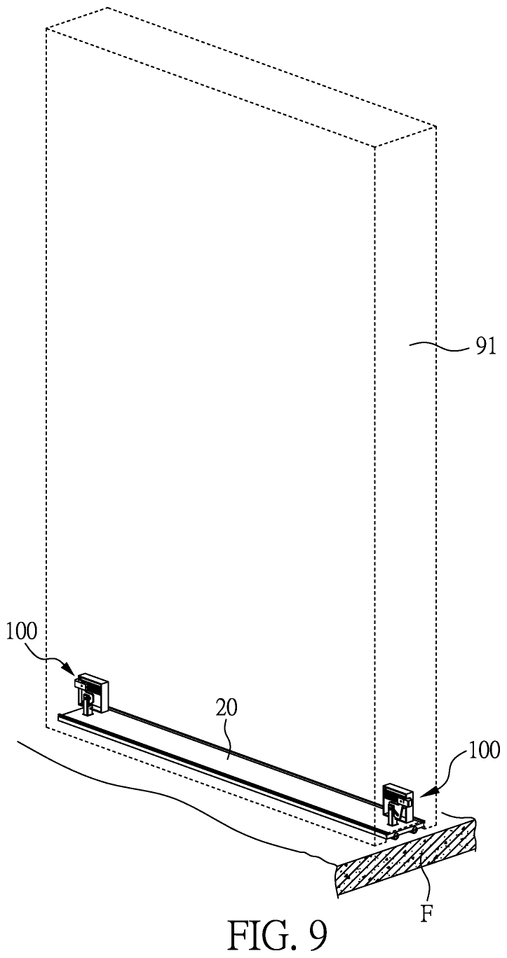

FIG. 9 is a schematic view illustrating the door panel sealing mechanism according to another embodiment of the present invention; and

The door panel sealing mechanism 100 of this embodiment includes two actuating devices 10 and a sealing device 20. The actuating device 10 includes a housing 1, an elastic element 2, a sliding element 3, a first interlocking element 4, and a second interlocking element 5. The housing 1 is provided with a first opening 11, a second opening 12, a first chamber 14, and a second chamber 15. The sliding element 3 extends out of the first opening 11. The second interlocking element 5 extends out of the second opening 12. The elastic element 2 is received in the first chamber 14 of the housing 1. The first interlocking element 4 is received in the second chamber 15.

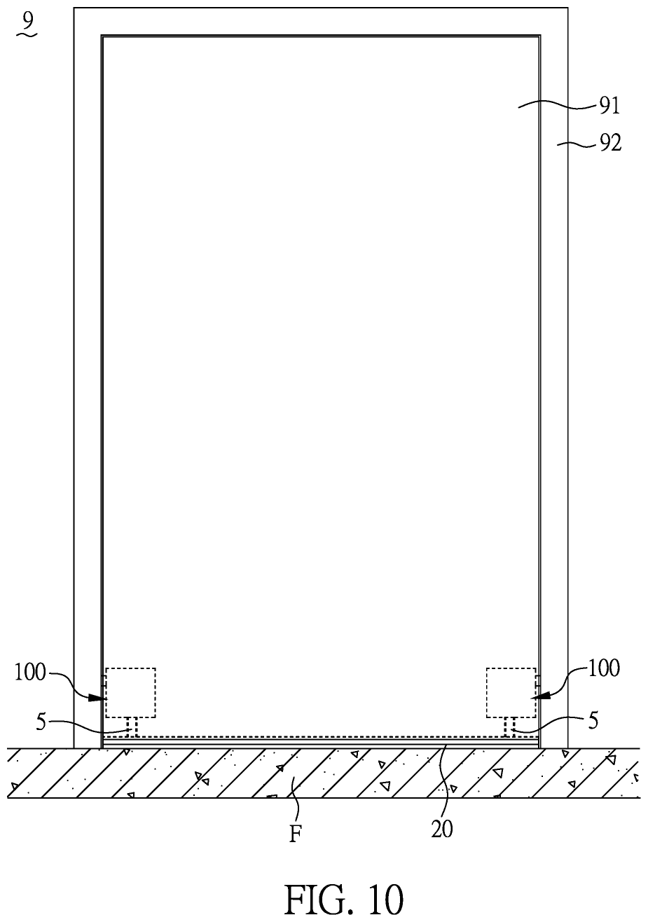

The sliding element 3 is provided with a first through hole 31, a second through hole 32, and a first protruding block 34. The sliding element 3 is arranged corresponding to a door frame 92 (see FIG. 10). Further, the elastic element 2 is arranged on the first protruding block 34 of the sliding element 3, such that a protrusion 42 of the first interlocking element 4 can be arranged and fixed in the first through hole 31 of the sliding element 3.

The first interlocking element 4 is provided with a guiding rail 41. The second interlocking element 5 is provided with a slot 51. The slot 51 is arranged corresponding to the guiding rail 41 of the first interlocking element 4. The first interlocking element 4 is disposed in the slot 51 of the second interlocking element 5. The second interlocking element 5 is arranged on the rail 41 of the first interlocking element 4 through a first fixing element 71. In this embodiment, the door panel sealing mechanism is mounted to the door panel 91.

Since the structure and acting mechanism of the door panel sealing mechanism 100 are substantially similar to the aforementioned, the detailed description is omitted.

### [The Structure of the Door 9 According to Another Embodiment]

FIG. 10 is a schematic view illustrating a door having the door panel sealing mechanism according to another embodiment of the present invention.

As shown in FIG. 10, and also in FIG. 8, the door 9 includes the door panel 91, the door frame 92, and the door panel sealing mechanism 10. The door panel sealing mechanism 100 is mounted to the door panel 91. The sealing device 20 is arranged on the door panel sealing mechanism 100 and is connected with the second interlocking element 5. Since the structure and acting mechanism of the door panel sealing mechanism 100 are substantially similar to the aforementioned, the detailed description is omitted.

Given the above, the door panel sealing mechanism 100 and the door 9 having the same, according to the present invention, are superior in terms of its easy construction, aesthetic appearance, and safety, because there is no need for an extra work on installing a threshold to be incorporated with the door panel, and thus can overcome the several inconveniences when arranging the threshold. Moreover, the purpose of airtight, waterproof, insect prevention, anti-smog, and fire prevention can be achieved. Further, through the provision of the interlocking device, the structure of the door panel sealing mechanism can be greatly simplified, so as to increase the stability of the door panel sealing mechanism and to provide better user experience.

Although the present invention has been explained in relation to its preferred embodiments, it is to be understood that many other possible modifications and variations can be made without departing from the scope of the invention as hereinafter claimed.

What is claimed is:

1. A door panel sealing mechanism, comprising:
two actuating devices, each including:
an elastic element;
a sliding element, arranged on the elastic element;
a first interlocking element, arranged on the sliding element and provided with a guiding rail; and
a second interlocking element, arranged on the guiding rail of the first interlocking element, and provided with a slot, wherein the slot is arranged corresponding to the guiding rail of the first interlocking element;
a sealing device, connected respectively with the second interlocking elements of the two actuating devices; and
an interlocking device, connected respectively with the first interlocking elements of the two actuating devices.

2. The door panel sealing mechanism as claimed in claim 1, wherein each of the actuating devices further includes a housing, the housing is provided with a first opening, a second opening, and a third opening, the sliding element corresponds to the first opening, the second interlocking element corresponds to the second opening, and the interlocking device passes through the third opening.

3. The door panel sealing mechanism as claimed in claim 1, wherein each of the actuating devices further includes a housing, the housing is provided with a first chamber and a second chamber, the elastic element is received in the first chamber, and the first interlocking element is received in the second chamber.

4. The door panel sealing mechanism as claimed in claim 1, wherein the sliding element is provided with a first through hole, and the first interlocking element is arranged in the first through hole.

5. The door panel sealing mechanism as claimed in claim 1, wherein the sliding element is provided with a second through hole, and the first interlocking element is provided with a second protruding block, and the second protruding block is arranged in the second through hole.

6. The door panel sealing mechanism as claimed in claim 1, wherein the sliding element includes a rolling element, and the rolling element has its axis of rotation be perpendicular to an elastically acting force of the elastic element.

7. The door panel sealing mechanism as claimed in claim 1, wherein the second interlocking element is arranged on the guiding rail of the first interlocking element by means of a first fixing element.

8. The door panel sealing mechanism as claimed in claim 1, wherein the sealing device includes a first sealing element and a second sealing element, the first sealing element is arranged beneath an underneath surface of the sealing device, and the second sealing element is arranged on a side surface of the sealing device.

9. The door panel sealing mechanism as claimed in claim 1, wherein the first sealing element and the second sealing element are made of rubber, Ethylene Vinyl Acetate foam (EVA), Polyethylene foam (PE), or their combination.

10. The door panel sealing mechanism as claimed in claim 1, wherein the interlocking device includes a first rod, a second rod, and an adjusting element, the first rod is connected with the first interlocking element of either one of the actuating devices, the second rod is connected with the first interlocking element of the other actuating device, and the adjusting element is arranged between the first rod and the second rod.

11. A door, comprising:
a door panel;
a door panel sealing mechanism, arranged on the door panel, wherein the door panel sealing mechanism comprises:
two actuating devices, each including:
an elastic element;
a sliding element, arranged on the elastic element;
a first interlocking element, arranged on the sliding element and provided with a guiding rail;
a second interlocking element, arranged on the guiding rail of the first interlocking element, and provided with a slot, wherein the slot is arranged corresponding to the guiding rail of the first interlocking element;
a sealing device, connected respectively with the second interlocking element of each actuating device; and
an interlocking device, connected respectively with the first interlocking element of each actuating device.

12. The door as claimed in claim 11, wherein each of the actuating devices further includes a housing, the housing is provided with a first opening, a second opening, and a third opening, the sliding element corresponds to the first opening, the second interlocking element corresponds to the second opening, and the interlocking device passes through the third opening.

13. The door as claimed in claim 11, wherein the housing is provided with a first chamber and a second chamber, the elastic element is received in the first chamber, and the first interlocking element is received in the second chamber.

14. The door as claimed in claim 11, wherein the sliding element is provided with a first through hole, and the first interlocking element is arranged in the first through hole.

15. The door as claimed in claim 11, wherein the sliding element is provided with a second through hole, the first interlocking element is provided with a second protruding block, and the second protruding block is arranged in the second through hole.

16. The door as claimed in claim 11, wherein the sliding element includes a rolling element, and the rolling element has its axis of rotation be perpendicular to an elastically acting force of the elastic element.

17. The door as claimed in claim 11, wherein the second interlocking element is arranged on the guiding rail of the first interlocking element by means of a first fixing element.

18. A door panel sealing mechanism, comprising:
at least one actuating device, including:
an elastic element;
a sliding element, arranged on the elastic element;
a first interlocking element, arranged on the sliding element and provided with a guiding rail; and
a second interlocking element, arranged on the guiding rail of the first interlocking element, and provided with a slot, wherein the slot is arranged corresponding to the guiding rail of the first interlocking element; and
a sealing device, connected with the second interlocking element of the actuating device.

19. The door panel sealing mechanism as claimed in claim 18, wherein the at least one actuating device includes two actuating device.

20. The door panel sealing mechanism as claimed in claim 18, wherein the door panel sealing mechanism is mounted to a door panel.
